(19) United States
(12) Patent Application Publication
(10) Pub. No.: US 2018/0253445 A1
(43) Pub. Date: Sep. 6, 2018

(54) GEO-POSITIONING INFORMATION INDEXING

(71) Applicant: ENTIT Software LLC, Sunnyvale, CA (US)

(72) Inventors: Jingjie Ni, Cambridge, MA (US); Ariel Cary-Huanca, Cambridge, MA (US); Vincent Xu, Cambridge, MA (US)

(21) Appl. No.: 15/765,297

(22) PCT Filed: Oct. 2, 2015
(86) PCT No.: PCT/US2015/053830

§ 371 Date: Apr. 2, 2018

(51) Int. Cl. G06F 17/30; G06T 17/00; G06T 17/05

(52) U.S. Cl. CPC G06F 17/30241; G06F 17/3028; G06T 17/05; G06T 17/005

(57) ABSTRACT

According to an example, an index for three-dimensional geographic data stores information regarding a set of spherical polygons. The index includes position information of the vertices and edges of the set of spherical polygons in a coordinate system. At least a subset of the edges of the set of spherical polygons are represented as arcs within the index. Geo-positioning information can be determined based on the index.

### BACKGROUND

Geospatial data may be used for many types of geospatial applications which may be related to Global Positioning System (GPS) devices, satellites traffic sensors etc. Many of these applications process geospatial data in real-time to provide location-based services and information in real-time. World Geodetic System (WGS), e.g., WGS84 which is the latest version of WGS, is an Earth-centered, Earth-fixed terrestrial reference coordinate system for geospatial information and is the reference system for GPS. WGS 84 is based on a consistent set of constants and model parameters that described the Earth's size, shape, gravity and geomagnetic fields. The Earth's center of mass is considered as an origin for the WGS 84 coordinate system. WGS 84 coordinates are defined in the three-dimensional (3D) space and are represented in longitude and latitude.

### BRIEF DESCRIPTION OF THE DRAWINGS

Features of the present disclosure are illustrated by way of example and not limited in the following figure(s), in which like numerals indicate like elements, and in which:

FIGS. 1A-B show computer systems comprising an index generating system and a 3D index, according to examples of the present disclosure;

FIG. 2 shows additional components that may be in the system of FIG. 1, according to an example of the present disclosure;

FIG. 3 shows the processing of two polygons by the system of FIG. 1, according to an example of the present disclosure;

FIG. 4 shows a tree data structure for a 3D index, according to an example of the present disclosure;

FIGS. 5 and 6 show methods for enhancing speed and accuracy of geo-spatial applications, according to examples of the present disclosure; and

FIG. 7 shows a method for generating a 3D index, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. In the present disclosure, the term “includes” means includes but not limited thereto, the term “including” means including but not limited thereto. The term “based on” means based at least in part on. In addition, the terms “a” and “an” are intended to denote at least one of a particular element.

Spatial indexing may be used for boosting calculation speed for geospatial computations. A polygonal Map (PM) quadtree data structure represents polygonal maps which may include collections of polygons, possibly containing holes, and is an example of a spatial index in a planar system. A large amount of GPS data is generated in the WGS84 coordinate system which is a 3D model of the Earth. When the GPS data generated in the 3D coordinate system is stored in a 2D structure such as a PM quadtree, it can result in the loss of information thereby decreasing the computational accuracy of calculations based on such stored data. Examples are described herein which enable storing the 3D data obtained from a 3D geospatial coordinate system, e.g., WGS84 coordinate system, in 2D data structures, such as PM quadtrees, which minimizes loss of information. Examples are described below with respect to the WGS84 coordinate system but the systems and methods described herein may use other 3D coordinate systems.

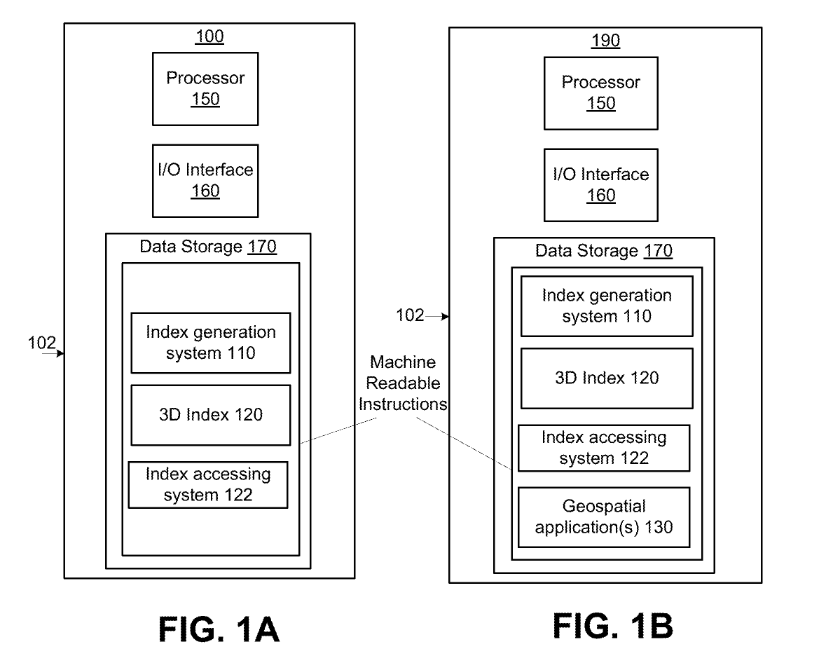

FIG. 1A shows a computer system 100 that can host an index generating system 110, the 3D index 120 that it generates and the geospatial applications(s) that use the 3D index 120. The indexing generating system 110 receives input data 102, for example, geospatial data of regions of the Earth's surface modeled as polygons in terms of their vertices. When the WGS84 system is employed to define a polygon, each of its vertices can be represented as a longitude/latitude pair. For example, a vertex v1 of the polygon=(longitude, latitude). Similarly, a set of spherical polygons defined in terms of their vertices can be received in the input data 102. At least a subset of the edges of the spherical polygons can be curved to form arcs instead of straight lines. A 2D index would store the edges of the set of spherical polygons as straight lines thereby resulting in loss of accuracy. The indexing generating system 110 is configured to convert the input data 102 from the WGS84 system to a 3D Cartesian coordinate system, such as the Earth-centered earth-fixed (ECEF) system. For example, the vertices of the set of spherical polygons are converted from the (longitude, latitude) format to the (x, y, z) format. The indexing generating system 110 further generates the 3D index 120 which comprises position information regarding the vertices and edges of the set of spherical polygons in the ECEF coordinate system wherein the subset of the edges of the set of spherical polygons are represented as arcs within the 3D index 120. As the data regarding the set of spherical polygons is stored in the 3D ECEF coordinate system, there is no loss of accuracy resulting in precise measurements for any calculations based on the index 102.

An index accessing system 122 enables one or more geospatial application(s) 130 which may also be in the computer system 100, such as shown in FIG. 1B, for accessing the 3D index 120 and retrieving the relevant information. The geospatial application(s) 130 can also be located on remote computer systems which are networked to the computer system 100 via the Internet or other communication networks. In one example, the geospatial application(s) 130 can include a location determination application which queries the index 120 for retrieving information that enables it to determine if a point lies in one of the regions represented by the set of spherical polygons. The query generated by the geospatial application 130 may comprise coordinates of the point in the WGS84 system. The index accessing system 122 can be configured to convert the coordinates to the ECEF system to retrieve and provide the requisite information from the 3D index to the querying geospatial application 130. The geospatial application can then determine, based on the information from the 3D index 120, if the point lies in one of the regions represented by the set of spherical polygons. For example, the index accessing system 122 can traverse through the tree data structure that forms the 3D index 120 to determine if the point lies within one of the spherical polygons. While using brute force algorithms without 3D index 120 requires Geospatial application(s) 130 to check each and every spherical polygons to determine which polygon the point is located in, it is not required when using the 3D index 120. As the 3D index 120 records the set of spherical polygons in a tree data structure, the index accessing system 122 traverses from the index tree root node to the right tree leaf node directly according to the point location information. Any other nodes not in that path do not comprise that point, and such nodes are not traversed by the index accessing system 122 thereby enhancing the speed of the information retrieval. Moreover, as the 3D index 120 stores the edges of the spherical polygons as arcs rather than as straight lines, it can give a more accurate result regarding the polygon that includes the point. For example, one of the geospatial application(s) 130 may be configured for projecting flight path for aero planes. Storing the edges of the spherical polygons precisely as arcs including their curvature information as opposed to approximating them as straight lines can lead to the flight paths being projected more accurately.

The computer system 100 includes a processor 150, an input/output (I/O) interface 160, and a data storage 170. The processor 150 may include a microprocessor operable to execute machine readable instructions to perform programmed operations. The data storage 170 may include volatile and/or non-volatile data storage, such as random access memory, memristors, flash memory, hard drives, and the like. The data storage 170 may store any information used by the index generating system 120, the index accessing system 122 and the geospatial application(s) 130. The data storage 170 can also store the 3d index 120 in an example. The 3D index 120 can also be stored in another remote computer system which is communicatively coupled to the computer system 100. Machine readable instructions may be stored in the data storage 170. The index generating system 110 and the geospatial application(s) 130 may comprise machine readable instructions stored in the data storage 170 and executed by the processor 150. The input/output interface 160 may include a network interface or another interface to enable I/O functions of the computer system 100 such as receiving the input data 102 or providing the results from the geospatial application(s) 130.

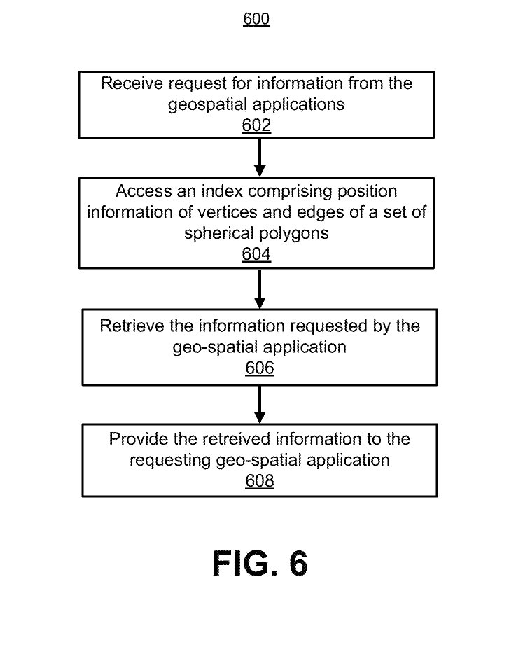

FIG. 1B shows computer system 190 which is the same as computer system 100 of FIG. 1A except the computer system 190 includes the geospatial application(s) 130. As indicated above, the geospatial application(s) 130 may be located in the computer system 190 or remotely from the computer system. Examples of the geospatial application(s) 130 may include mapping applications, flight plan applications, or any location-based application. The geospatial application(s) 130 may provide coordinates in the WGS84 coordinate system to convert to the ECEF coordinate system, such as described with respect to FIG. 6.

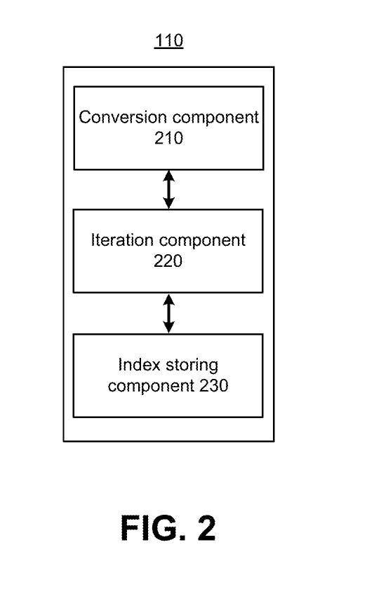

FIG. 2 illustrates components within the index generation system 110 in accordance with one example. The components can comprise one or more of machine executable instructions or hardware comprised in the computer system 100. The index generation system can include a conversion component 210, an iteration component 220 and an index storing component 230. The input data 102 regarding a set of spherical polygons which comprises a sequence of vertices corresponding to a respective spherical polygon can be received in WGS84 coordinate system. The conversion component 210 converts it from the WGS84 to the 3D ECEF coordinate system. Therefore, the latitude, longitude coordinates of the WGS84 coordinate system are converted to the x, y, z coordinates.

The iteration component 220 can comprise instructions to determine the initial positions of the set of spherical polygons within the ECEF quadrant space based on the vertices. The quadrant space is then subdivided based on PM quadtree rules in one example. PM quadtree rules may include: at most, one vertex can lie in a region represented by a quadtree leaf node; if a quadtree leaf node's region contains a vertex, then it can contain no q-edge that does not include that vertex; if a quadtree leaf node's region contains no vertices, then it can contain, at most, one q-edge; and each region's quadtree leaf node is maximal. For example, a quadrant comprising a spherical polygon can be iteratively subdivided into four quadrants until predetermined condition is met. In an example, the predetermined condition can include a quadrant comprising a single vertex of the spherical polygon. During the iterations, empty quadrants that do not comprise any vertices of the spherical polygon being analyzed are not sub-divided further during the iterative sub-division process. A quadrant that meets the predetermined condition is not sub-divided further. The iterative process therefore ends when all the non-empty quadrants that do not meet the predetermined condition are completely decomposed into either empty quadrants or quadrants that meet the predetermined condition.

The index storing component 230 stores the index 120 in a tree data structure such as a PM quadtree. The nodes of the PM quadtree represent quadrants in a coordinate space comprising the set of spherical polygons. The information regarding the vertices and the edges of the spherical polygons and the quadrants associated therewith is stored in the nodes of the tree data structure. The edges of the spherical polygons are stored as arcs in the tree data structure. As the set of spatial polygons are organized in an index tree hierarchical structure during the processing, accessing the index 120 enables the geospatial applications 130 to retrieve the results by traversing the index tree once which is faster than would be retrieved if a brute force algorithm were used as the brute force algorithm would require processing each and every spatial polygon one by one.

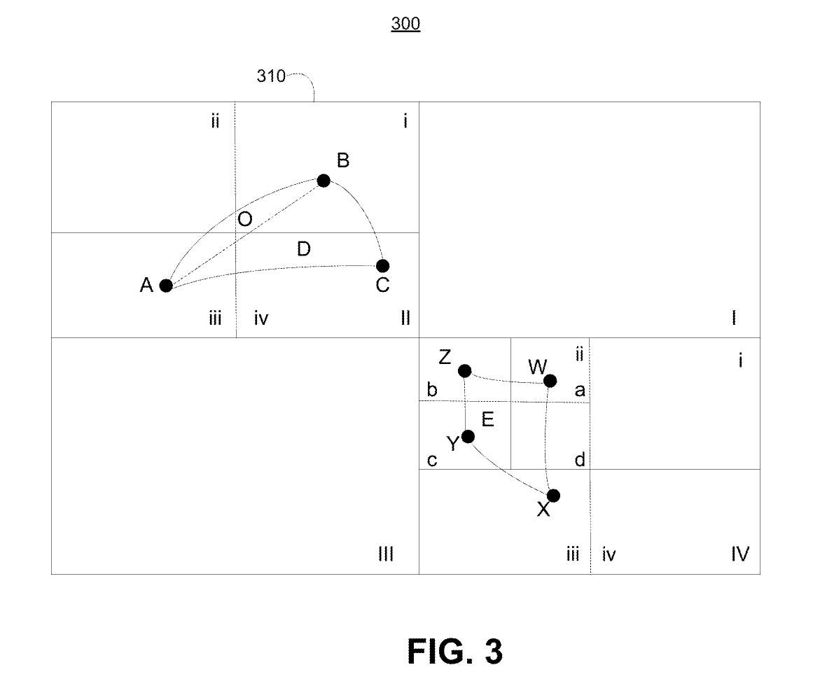

FIG. 3 is a schematic diagram 300 that shows an example of two spherical polygons D and E comprised in the quad space 310 processed by the index generation system 110 for generating the 3D index 120. The 3D index 120 in one example, forms a PM quadtree structure. The polygons D and E are processed by the index generation system 110 in the quad space per PM quadtree rules. The input data 102 includes information regarding polygon D which is defined in terms of its vertices A, B and C and edges which form arcs AB, BC and AC. The input data 102 also includes the information regarding polygon E is defined in terms of its vertices W, X, Y and Z and edges which form arcs WX, ZY, YZ and ZW. Although the below description describes the processing of the polygons D and E serially, it can be appreciated that the index generating system 110 can process any number of polygons in parallel to store their data in the 3D index 120.

The entire coordinate space is divided into four quadrants and the initial positions of the polygon D and E is determined to be in the second and the fourth quadrants respectively. The initial position of the polygon D is determined to be in the second quadrant II. Per one of the quadtree rules, the quadrant(s) comprising the polygons D and E should be iteratively subdivided until a predetermined condition is met while the empty quadrants are disregarded in further processing. In some embodiments, the predetermined condition can include a quadrant comprising a single vertex of the polygon D. Alternately, when it is determined that a quadrant comprises a single vertex of the polygon D, the quadrant is no longer subdivided. Accordingly, the second quadrant II and the fourth quadrant IV are selected for further processing while the first quadrant I and the third quadrant III are terminated from further processing. When the second quadrant II is subdivided, it is determined that each of the sub-quadrants i, iii and iv include a single vertex B, A and C of the polygon D while the sub-quadrant ii includes the arced edge AB. Further processing of the second quadrant is halted as the quadtree rule that requires a single vertex per sub-quadrant is met for each of the i, iii and iv while the second sub-quadrant ii includes one arced edge AB. The index generation system 110 halts the processing of the polygon D per the PM quadtree rules and stores within the 3D index 120, the information regarding the quadrants i, iii and iv each of which includes a single vertex B, A and C of the polygon D and the information regarding the sub-quadrants that include the arced edges AB, BC and AC. And the information regarding the quadrant ii which includes the arced edge AB.

It can be appreciated that had the polygon D been processed and stored in a 2D data structure, the edges AB, BC and AC would have been stored as straight lines rather than as arcs thereby losing accuracy. For example, the edge AB would have been stored as a straight line in a 2D data structure and thereby the 2D index data structure would have recorded the point O as being on the left side of line segment AB and outside of the polygon D. Moreover, the sub-quadrants i, iii and iv would have been recorded as comprising the line segment AB thereby causing errors in any projections or further calculations that are based on such 2D indexes. On the other hand, as the edge AB is recorded as an arc in the 3D index 120, it is further accurately recorded that the point O is in the right side of the arc AB and hence lies within the polygon D. Furthermore the sub-quadrants and iii are accurately recorded as comprising the arc AB. Hence, further calculations based on the 3D index 120 can be more accurate than the corresponding calculations based on the 2D data structure as described above. In one example, a flight path based on the 3D index 120 would be more accurate than a flight path obtained from a 2D data structure. Similarly, a location determination application would accurately assess O as lying within the region represented by polygon D.

The initial positions of the polygons D and E are shown as being entirely located within a single quadrant on the first iteration only by the way of illustration. A polygon may have its initial position comprised in a plurality of quadrants on the first iteration and it may be processed in accordance with the methodologies described herein. Now proceeding to the processing of the polygon E, it is determined on the first iteration that polygon E is entirely comprised in the fourth quadrant IV. On the second iteration, the fourth quadrant IV is further divided in four sub-quadrants and it is determined that three of the vertices W, Y and Z are in the second sub-quadrant ii while the fourth vertex X is in the third sub-quadrant iii. The first sub-quadrant i and the fourth sub-quadrant iv are empty and hence are terminated in further processing according to one of the PM quadtree rules. Moreover, as the third sub-quadrant has only on vertex X, it is also not sub-divided in further iterations per another PM quadtree rule. The second sub-quadrant ii which includes the three vertices W, Y and Z is further sub-divided into four more sub-quadrants a, b, c and d on a third iteration. Again each of the sub-quadrants a, b and c respectively contain vertices W, Z and Y while the sub-quadrant d includes one edge WX. Therefore, the sub-quadrants a, b, c and d are no longer sub-divided per the PM quadtree rule that requires the iterations to halt when each sub-quadrant comprises a single vertex. As none of the sub-quadrants need further processing, the iterations are halted and the information regarding the vertices W, X, Y, Z, the sub-quadrants that comprise them, the edges WX, XY, YZ and WZ and the sub-quadrants they pass through is stored in the index 120.

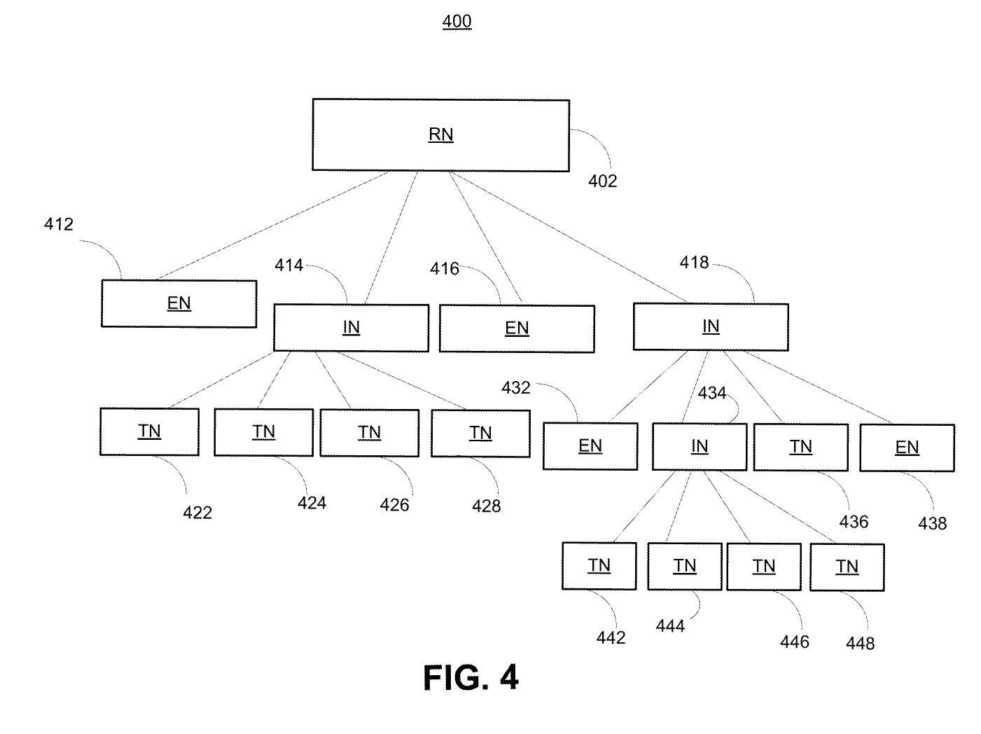

FIG. 4 shows the index 120 stored as a PM quadtree data structure 400 wherein each node of the PM quadtree 400 represents a quadrant or a sub-quadrant in the quad space 310. The PM quadtree is an extension of the traditional point region quadtree which is used for storing information about points within a region. In particular, the nodes of the PM quadtree data structure 400 store the information corresponding to the polygons D and E discussed above in FIG. 3. The node 402 is the root node which represents the entire quad space 310. The inner nodes 414, 418 and 434 represent quadrants that have multiple vertices and need to be further decomposed. The terminal nodes 422, 426, 428, 436, 442, 444, 446 and 424, 448 (terminal nodes comprising 0 vertices and one edge) of the PM quadtree correspond to the quadrants with a single vertex or quadrants that satisfy the PM quadtree rule for terminating the iterations. The empty nodes 412, 416, 432 and 438 represent empty quadrants that do not need to be further decomposed.

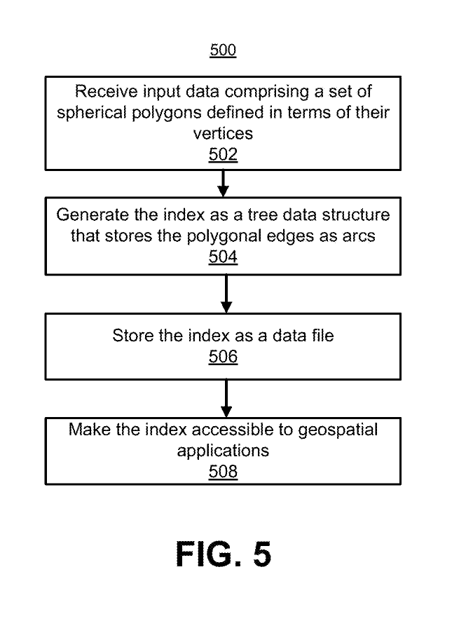

FIG. 5 illustrates a method 500 for enabling faster and more accurate execution of geospatial applications 130. The method can be performed by the index generation system 110 and the index accessing system 122 shown in FIG. 1. At 502, the input data 102 comprising information regarding the vertices of a set of spherical polygons is initially received. A spherical polygon may be represented as a sequence of its vertices. In an example, each of the spherical polygons can represent at least a portion of the earth's surface region. Table 1 below represents an example of the input data 102 that can be received by the index generating system 110.

TABLE 1

| polygon_id | polygon |
|---|---|
| 1 | polygon ((30 20, 50 10, 40 30, 30 20) |
| 2 | polygon ((−1 −1. 1 −1, 11, −1 1, −1 −1)) |
| 3 | polygon ((1 2, 2 1, 3 2, 2 3, 1 2)) |

At 504, the index 120 is generated from the input data 102. The index 120 comprises a tree data structure such as a PM quadtree structure and stores information regarding the vertices and edges of the set of spherical polygons in a coordinate system such as an ECEF coordinate system. Furthermore, the index 120 stores information in 3D such as storing the edges as curves or arcs unlike the data structures that project the information into 2D space prior to storing it. Thus, in a 2D data structure, the edges of the polygons are approximated to straight lines. The capacity of the index 120 to store the received 3D information in 3D format without projection into 2D format enhances the accuracy of the resulting calculations which are based on the information in the index 120. At 506, the index 120 is stored as a data file in a computer readable storage medium 170. At 508, the index 120 is made accessible to different geospatial application(s) 130 which can be stored either locally or may be accessing the index 120 from remote locations.

FIG. 6 illustrates a method 600 for enabling faster and more accurate execution of geospatial applications 130. The method can be performed by the index accessing system 122 shown in FIG. 1. At 602, a request for information can be received from one or more of the geo-spatial application(s) 130. In an example, the request can coordinates in the WGS84 coordinate system. The index accessing system 122 can also be configured to convert the information in the request to ECEF coordinate system prior to accessing the index 120. At 604, the 3D index 120 comprising the position information of the vertices and edges of the polygons is accessed. At 606, the information requested by the geo-spatial application is retrieved. In an example, the 3D index 120 can comprise a tree data structure such as a PM quadtree and retrieving the requested information comprises traversing the nodes of the PM quadtree data structure. The retrieved information is transmitted to a requesting application at 608. If the requesting application is a remote application, the retrieved information can be transmitted via wired or wireless communication systems. In an example, geo-positioning information can be requested by one of the geo-spatial application(s). Thus, geo-positioning information can be obtained by the geo-spatial application(s) 130 via accessing the index 120. The index 120 is in addition to storing the information regarding the spherical polygons, may also provide information regarding the various points comprised in the regions represented by the spherical polygons. This not only enables faster execution the geospatial application(s) 130 than a brute force methodology but also results in greater accuracy of calculations based on the information comprised in the index 120.

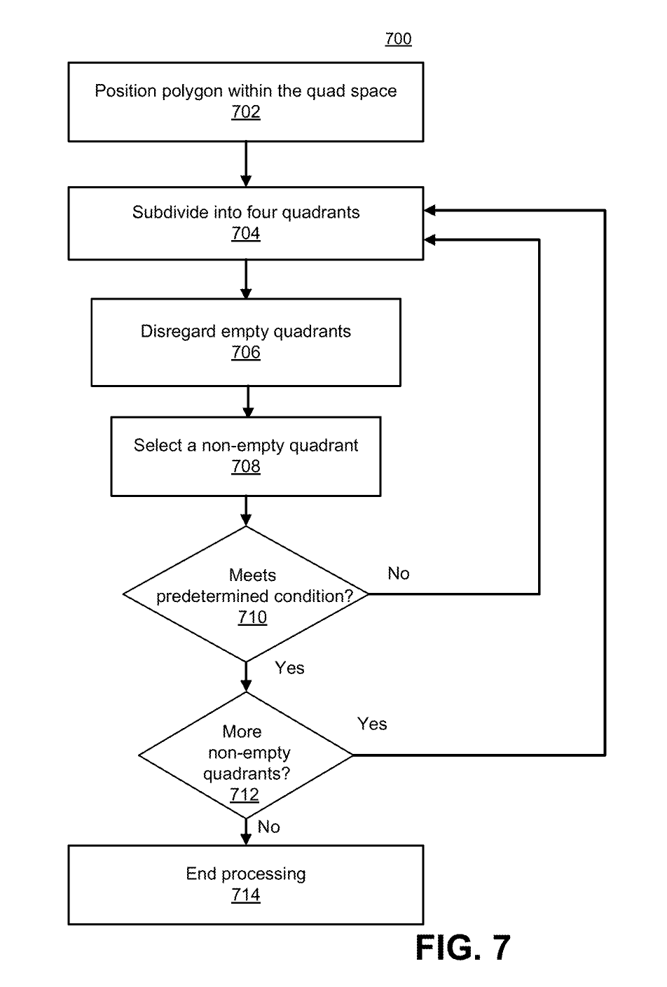

FIG. 7 illustrates a method of generating the index 120. The method can be performed by the index generation system 110 shown in FIG. 1. The processing of one spherical polygon is discussed in detail below. It can be appreciated that any number of spherical polygons that may be received in the input data 102 can be similarly processed for storing their information in the index 120. At 702, a spherical polygon is initially positioned in the coordinate space or quad space based on its vertices. At 704, the quad space is subdivided into four quadrants. The empty quadrants that do not have any polygon vertices are terminated from further processing at 706. At 708, a non-empty quadrant is selected and it is determined at 710 if the selected non-empty quadrant meets a predetermined condition. In an example, the predetermined condition can be the presence of one polygon vertex in the quadrant.

If, at 710, it is determined that the predetermined condition is not met, then the quadrant comprises multiple vertices of a given spherical polygon. Or the quadrant corresponds to an inner node of the PM quadtree that can be further decomposed or processed. Therefore, the method returns to 704 for further decomposing or sub-dividing the quadrant in the next iteration. If the predetermined condition is met for the non-empty quadrant, it is determined at 712 if there are further non-empty quadrants. If no further non-empty quadrants remain, it can be concluded that the quadrants pertain to either empty nodes or terminal nodes. Hence, the processing terminates at 714.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims, and their equivalents, in which all terms are meant in their broadest reasonable sense unless otherwise indicated.

What is claimed is:

1. A system for indexing three-dimensional (3D) geographic data, comprising a processor to:
receive input data regarding a set of spherical polygons, the input data comprising a plurality of sequences of vertices, each sequence of vertices corresponding to a respective spherical polygon;
generate an index comprising position information of the vertices and edges of the set of spherical polygons in a coordinate system wherein at least a subset of the edges of the set of spherical polygons are represented as arcs; and
determine geo-positioning information based on the index.

2. The system for claim 1, further comprising a non-transitory computer readable storage medium to store the index.

3. The system of claim 1, wherein the input data comprises the plurality of sequence of vertices in WGS84 (World Geodetic System) coordinate system and the processor is to:
convert the input data into earth-centered earth fixed (ECEF) coordinate system.

4. The system of claim 1, wherein the index comprises a polygonal map (PM) quadtree.

5. The system of claim 4, wherein nodes of the PM quadtree represent quadrants in a coordinate space comprising the set of spherical polygons.

6. The system of claim 4, the processor further to:
store in each node in the PM quadtree, further information regarding position of the quadrant represented by the node, spherical polygons that intersect the quadrant, vertices of the spherical polygons that intersect the quadrant and edges of the spherical polygons that intersect the quadrant.

7. The system of claim 4, the processor further to:
position each polygon of the set of spherical polygons in an initial position in the coordinate space based on the respective sequence of vertices.

8. The system of claim 7, the processor further to:
for the set of spherical polygons:
iteratively divide non-empty quadrants of a space comprising the spherical polygon based on PM quadtree rules; and
disregard from further processing, empty quadrants that do not comprise any vertex or edge of the spherical polygon.

9. The system of claim 1, the processor to determine geo-positioning information further to:
receive position information regarding one or more points on Earth's surface;
determine if the points lie in one or more of the spherical polygons based on the index, the set of spherical polygons representing regions on the Earth's surface.

10. The system of claim 9, the processor further to:
traverse a tree data structure representing the index according to the position information, wherein the traversal to an empty nodes being indicative of the point not intersecting the spherical polygons and the traversal to a non-empty node of the tree data structure that comprise data being indicative of the point intersecting with one of the spherical polygons which intersect with the non-empty node.

11. The system of claim 1, wherein the geo-positioning information is location information of a geographic location.

12. A method for providing geo-positioning information, comprising:
receiving, by a computing device, a request for geo-positioning information from an application;
accessing, by the computing device, an index comprising position information of vertices and edges of a set of spherical polygons in a coordinate system wherein at least a subset of the edges of the set of spherical polygons are represented as arcs;
retrieving, by the computing device from the index, the requested geo-positioning information; and
providing, by the computing device, the retrieved geo-positioning information to the requesting application.

13. The method of claim 12, wherein receiving, the request for geo-positioning information further comprises:
receiving, by the computing device, data in the request in World Geodetic System 84 (WGS84) coordinate system; and
converting, by the computing device, the data into earth-centered earth fixed (ECEF) coordinate system.

14. The method of claim 12, wherein accessing the index further comprises:
traversing, by the computing device, a tree data structure comprised in the index, the tree data structure comprises the position information of the vertices and the edges of the spherical polygons and wherein each node in the tree corresponds to a quadrant in a coordinate space.

15. A non-transitory computer readable storage medium storing machine readable instructions executable by at least one processor to:
receive a request for information from a geo-spatial application;
access an index comprising:
a polygonal map (PM) quadtree data structure storing position information regarding a plurality of spherical polygons, the position information comprising coordinates of a plurality of vertex sequences in ECEF coordinate system, each vertex sequence corresponds to a respective spherical polygon of the plurality of spherical polygons, and
the position information comprising data regarding edges of the plurality of spherical polygons wherein at least a subset of the edges are represented as arcs;
retrieve from the index, the requested geo-positioning information; and
provide the retrieved information to the requesting geo-spatial application.
